(19) United States
(12) Patent Application Publication
(10) Pub. No.: US 2006/0136963 A1
(43) Pub. Date: Jun. 22, 2006

(54) Apparatus and method for combining video and skin in embedded system

(76) Inventors: Hyun Woo Oh, Daejeon-city (KR); Kee Seong Cho, Daejeon-city (KR); Tae Ho Yeam, Daejeon-city (KR); Eung Ha Kim, Daejeon-city (KR); Hwa Suk Kim, Daejeon-city (KR); Sung Jin Moon, Daejeon-city (KR); Hyun Jin Lee, Daejeon-city (KR); Hyun Soon Shin, Daejeon-city (KR); Byung Sun Lee, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/139,179

(22) Filed: May 27, 2005

(30) Foreign Application Priority Data
Dec. 16, 2004 (KR) 10-2004-0107229

(51) Int. Cl. H04N 7/10

(52) U.S. Cl. 725/35

(57) ABSTRACT

Provided are an apparatus for combining video and a player skin in an embedded system having no graphics card, and a method used by the apparatus. The apparatus includes: an application program; a virtual frame buffer; a graphics processor; and an image processor. The apparatus processes a video player skin image using a virtual frame buffer without a graphics card, and stores the processed video player skin image in a region of a physical main memory, thereby requiring no high-performance CPU, simplifying the hardware structure, and embodying a superior application program without needing a frame buffer and driver compatible with an operating system.

### BACKGROUND OF THE INVENTION

This application claims the benefit of Korean Patent Application No. 10-2004-0107229, filed on Dec. 16, 2004, in the Korean Intellectual Property Office, the disclosure of which is incorporated herein in its entirety by reference.

1. Field of the Invention

The present invention relates to an apparatus for combining video and a skin that outputs various kinds of information on video on a player skin or other screen, and more particularly, to an apparatus for combining video and a skin in an embedded system using a virtual frame buffer.

2. Description of the Related Art

There are two conventional methods of combining video and its related information and a skin in a system.

FIG. 1 is a block diagram illustrating a conventional method of combining video and a skin. Referring to FIG. 1, the conventional method combines a skin and a video file in a program using a high-performance CPU. The method is mainly used in a personal computer. An application program 103 supported by the Windows or Linux operating system receives a skin source 101 of a skin and a video source 102 of video. The received content is combined via a graphics library 104 and stored in a frame buffer 105.

The content stored in the frame buffer 105 is mapped to a video memory 107 from a graphics card driver 106. The content mapped to the video memory 107 is output via a frame buffer 109 and a graphics card 110 according to an output routine of a graphics card driver 108.

FIG. 2 is a block diagram illustrating another conventional method of combining video and a skin. Referring to FIG. 2, a video player skin source 201 and a video source 212 are transferred via a first application program 202 and a second application program 213, respectively, in which the video player skin source 201 is transferred to a frame buffer 204 via a graphics library 203 as shown in FIG. 1. The transferred image is mapped to a video memory 206 via a graphics card driver 205. The mapped image is stored in a frame buffer 208 according to an output routine of a graphics card driver 207. The system may include an image processing chip 211 for MPEG encoding and decoding, in which case a player skin image is transferred from the frame buffer 208 to an image processing chip device driver 210 via a third application program 209.

The video source 212 is transferred to the image processing chip device driver 210 via the second application program 213. The transferred video source is combined with the skin image received from the frame buffer 208. The combined image is output via the image processing chip 211.

As described above, the conventional methods suggested in FIGS. 1 and 2 process a player skin image using a graphics card compatible with a standard personal computer system.

However, since an embedded system has parts and space unnecessary for a general-purpose graphics card, a graphics card device driver compatible with various embedded operating systems is required for the recognition and operation of a graphics card. In particular, the method shown in FIG. 1 uses a program to process a player skin image and video, which requires a high-performance CPU. Such a high-performance CPU increases the cost, power consumption and heat output of the embedded system.

### SUMMARY OF THE INVENTION

The present invention provides an apparatus for combining video and a player skin in an embedded system having no graphics card, and a method used by the apparatus.

The present invention also provides a computer readable medium having embodied thereon a computer program for executing a method of combining video and a player skin in an embedded system.

According to an aspect of the present invention, there is provided an apparatus for combining video and a player skin in an embedded system having no graphics card, the apparatus comprising: an application program which reads a video player skin source internally stored in the embedded system and a video source transferred from outside, and periodically reads a video player skin image stored in a main memory; a virtual frame buffer which is mapped to a predetermined region of the main memory, and stores image information in the mapped main memory or reads video skin image information stored in the main memory; a graphics processor which generates a video player skin image by processing the video player skin source read by the application program and mapping the generated video player skin image to the virtual frame buffer, periodically reads the video player skin image stored in the main memory via the virtual frame buffer in response to the control of the application program, and provides the video player skin image to the application program; and an image processor which receives the video source and the video player skin image read by the application program, combines the video and the video player skin image, and outputs the combined image.

According to another aspect of the present invention, there is provided a method of combining video and a player skin in an embedded system having no graphics card that includes a virtual frame buffer mapped to a predetermined region of the main memory, storing image information in the mapped main memory or reading video skin image information stored in the main memory, the method comprising: (a) reading a video player skin source internally stored in the embedded system and a video source transferred from outside; (b) generating a video player skin image by processing the video player skin source read in (a) and mapping the generated video player skin image to the virtual frame buffer; (c) storing the video player skin image mapped to the virtual frame buffer in a region of the main memory; (d) periodically reading the video player skin image stored in the main memory by controlling the virtual frame buffer; and (e) combining the video source read in (a) and the video player skin image read in (d) and outputting the combined image.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a conventional method of combining video and a skin;

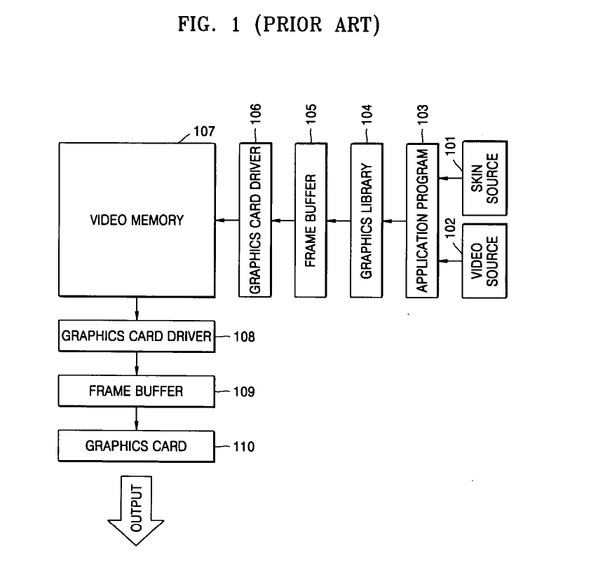

FIG. 2 is a block diagram illustrating another conventional method of combining video and a skin;

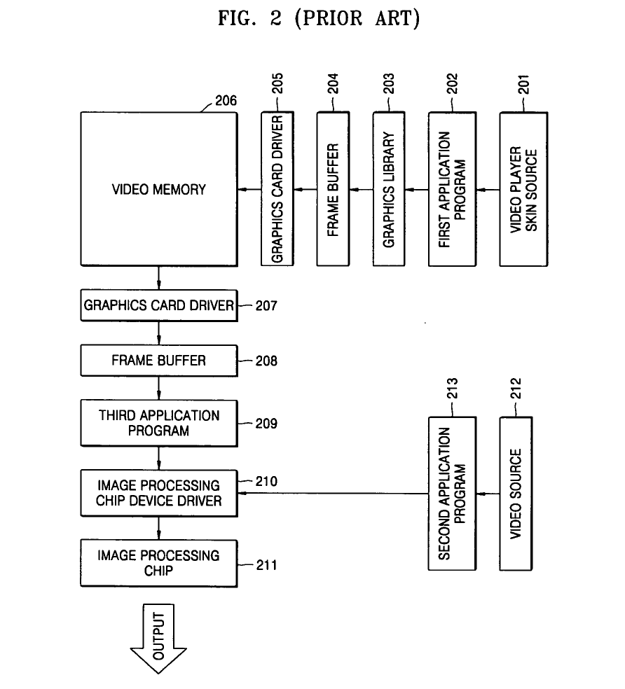

FIG. 3 is a block diagram illustrating an apparatus for combining video and a player skin in an embedded system according to an embodiment of the present invention; and

FIG. 4 is a flowchart illustrating a method of combining video and a player skin in an embedded system used by the apparatus shown in FIG. 3.

### DETAILED DESCRIPTION OF THE INVENTION

The present invention will now be described more fully with reference to the accompanying drawings.

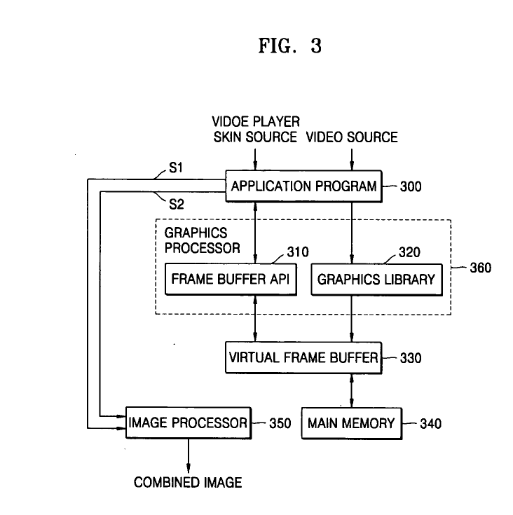

FIG. 3 is a block diagram illustrating an apparatus for combining video and a player skin in an embedded system according to an embodiment of the present invention. Referring to FIG. 3, the apparatus comprises an application program 300, a graphics processor 360, a virtual frame buffer 330, an image processor 350, and a main memory 340. The graphics processor 360 includes a frame buffer API (Application Program Interface) 310 and a graphics library 320.

The application program 300 reads a video player skin source stored in the embedded system, provides the video player skin source to the graphics library 320, reads a video source transmitted from outside, and provides the video source S1 to the image processor 350. The application program 300 reads a video player skin image S2 from the virtual frame buffer 330 through the frame buffer API 310 and provides the video player skin image S2 to the image processor 350. In this case, the application program 300 provides the video source S1 and the video player skin image S2 to the image processor 350 using PCI communication or interprocess communication (IPC).

The graphics processor 360 generates a video player skin image by processing the video player skin source read by the application program 300, and maps the generated video player skin image to the virtual frame buffer 330. The graphics processor 360 periodically reads the video player skin image stored in the main memory 340 via the virtual frame buffer 330 in response to the control of the application program 300, and provides the video player skin image to the application program 300. The graphics library 320 generates a video player skin image by processing the video player skin source read by the application program 300, and provides the generated video player skin image to the virtual frame buffer 330. The frame buffer API 310 converts the video player skin image provided to the virtual frame buffer 330 into a GUI (graphic user interface) type image and maps the converted video player skin image to the virtual frame buffer 330. The frame buffer API 310 periodically reads the video player skin image stored in the main memory 340 via the virtual frame buffer 330 in response to the control of the application program 300, and provides the video player skin image to the application program 300.

The virtual frame buffer 330 is mapped to a predetermined region of the main memory 340, and stores the video player skin image converted by the frame buffer API 310 into the GUI type image in the mapped main memory 340. The virtual frame buffer 330 is independent of the embedded system, unlike a general frame buffer compatible with a graphics card used with a graphics card device driver. The general frame buffer allocates a region in a video memory of a graphics card and stores an image in that region, whereas the virtual frame buffer 330 allocates a region by a resolution in a region of the main memory 340. The one megabyte of the main memory 340 is used for a 16-bit resolution 640×480 region. The virtual frame buffer 330 does not store an image in a virtual memory region like a conventional frame buffer, but stores an image in a physical memory region and transfers image data between different processors via the virtual frame buffer 330.

The image processor 350 combines video and a video player skin image transferred to the application program 300, and outputs the combined image.

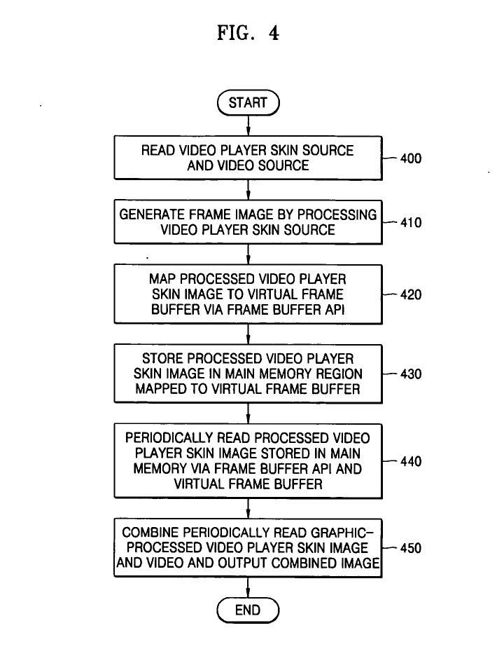

FIG. 4 is a flowchart illustrating a method of combining video and a player skin in an embedded system, used by the apparatus shown in FIG. 3. The method of combining video and a player skin in an embedded system is described referring to FIGS. 3 and 4.

The application program 300 reads a video player skin source from a file and a video source provided from outside, and provides the video player skin source to the image processor 350 (Operation 400).

The graphics library 320 generates a video player skin image by processing the video player skin source read by the application program 300, and provides the generated video player skin image to the virtual frame buffer 330 (Operation 410).

The frame buffer API 310 converts the video player skin image provided from the graphic library 320 to the virtual frame buffer 330 in a GUI-type image, and maps the converted video player skin image to the virtual frame buffer 330 (Operation 420).

The virtual frame buffer 330 is mapped to a predetermined region of the main memory 340, and stores the video player skin image converted by the frame buffer API 310 in the GUI-type image in the mapped main memory 340 (Operation 430).

The application program 300 periodically reads the video player skin image stored in the main memory 340 via the frame buffer API 310 and the virtual frame buffer 330, and provides the video player skin image to the image processor 350 (Operation 440).

The image processor 350 combines the video and the video player skin image provided by the application program 300, and outputs the combined image (Operation 450).

It is possible for the present invention to be realized on a computer-readable recording medium as computer-readable code. Computer-readable recording media includes every kind of recording device that stores computer system-readable data. ROMs, RAMs, CD-ROMs, magnetic tapes, floppy discs, optical data storage, etc. are examples of a computer-readable recording medium. Computer-readable recording media can also be realized in the form of a carrier wave (e.g., transmission through the internet). A computer-readable recording medium can be dispersed in a network-connected computer system, to be executed as computer-readable code by a distributed method. A functional program, code and code segments used to implement the present invention can be derived by a skilled computer programmer, from the description of the invention contained herein.

As described above, an apparatus for combing video and a player skin in an embedded system, and a method used by the apparatus, process a video player skin image using a virtual frame buffer without a graphics card and store the processed video player skin image in a region of a physical main memory, thereby requiring no high-performance CPU, simplifying the hardware structure, and embodying a superior application program without needing a frame buffer and driver compatible with an operating system.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for combining video and a player skin in an embedded system having no graphics card, the apparatus comprising:
an application program which reads a video player skin source internally stored in the embedded system and a video source transferred from outside, and periodically reads a video player skin image stored in a main memory;
a virtual frame buffer which is mapped to a predetermined region of the main memory, and stores image information in the mapped main memory or reads video skin image information stored in the main memory;
a graphics processor which generates a video player skin image by processing the video player skin source read by the application program and mapping the generated video player skin image to the virtual frame buffer, periodically reads the video player skin image stored in the main memory via the virtual frame buffer in response to the control of the application program, and provides the video player skin image to the application program; and
an image processor which receives the video source and the video player skin image read by the application program, combines the video and the video player skin image, and outputs the combined image.

2. The apparatus of claim 1, wherein the application program provides the video source and the video player skin image to the image processor using PCI communication or interprocess communication (IPC).

3. The system of claim 1, wherein the graphics processor comprises:
a graphics library which generates a video player skin image by processing the video player skin source read by the application program and provides the video player skin image to the virtual frame buffer; and
a frame buffer API which converts the video player skin image provided from the graphics library to the virtual frame buffer into a GUI (graphic user interface)-type image, maps the converted video player skin image to the virtual frame buffer, periodically reads the video player skin image stored in the main memory via the virtual frame buffer in response to the control of the application program, and provides the video player skin image to the application program.

4. A method of combining video and a player skin in an embedded system having no graphics card that includes a virtual frame buffer mapped to a predetermined region of the main memory, storing image information in the mapped main memory or reading video skin image information stored in the main memory, the method comprising:
(a) reading a video player skin source internally stored in the embedded system and a video source transferred from outside;
(b) generating a video player skin image by processing the video player skin source read in (a) and mapping the generated video player skin image to the virtual frame buffer;
(c) storing the video player skin image mapped to the virtual frame buffer in a region of the main memory;
(d) periodically reading the video player skin image stored in the main memory by controlling the virtual frame buffer; and
(e) combining the video source read in (a) and the video player skin image read in (d) and outputting the combined image.

5. The method of claim 4, wherein operation (b) comprises:
(b1) generating a video player skin image by processing the video player skin source read in (a) using a graphics library; and
(b2) mapping the video player skin image generated in (b1) to the virtual frame buffer using a frame buffer API.

6. The method of claim 5, wherein the frame buffer API converts the video player skin image generated in (b1) into a GUI-type image and maps the converted video player skin image to the virtual frame buffer.
